(19) United States
(12) Patent Application Publication
(10) Pub. No.: US 2012/0293861 A1
(43) Pub. Date: Nov. 22, 2012

(54) System and Method for Correcting Astigmatism Caused by an Aircraft Canopy

(75) Inventors: James A. Harder, Bedford, TX (US); Michaelene W. Sprague, Coppell, TX (US)

(73) Assignee: Elbit Systems of America, LLC, Fort Worth, TX (US)

(21) Appl. No.: 13/110,319

(22) Filed: May 18, 2011

(51) Int. Cl. G02B 13/14; G02B 27/00

(52) U.S. Cl. 359/356; 359/642

(57) ABSTRACT

In a method embodiment, a method for correcting astigmatism caused by an aircraft canopy comprises receiving at a compensator module a plurality of light rays that have been refracted by an aircraft canopy. At least two of the refracted light rays have respective foci different from one another and propagate in respective planes that are substantially perpendicular to one another, such that astigmatism occurs. The method further includes using the compensator module to substantially compensate for the astigmatism by providing astigmatic power to the received plurality of light rays. The method also includes providing the plurality of light rays having the astigmatic power compensation to an imaging module. The imaging module is configured to generate imagery using the plurality of light rays having the astigmatic power compensation.

### TECHNICAL FIELD

This invention relates generally to imaging systems, and more particularly to a system and method for correcting astigmatism caused by light transmissive structures having irregular or tonic curvatures, such as an aircraft canopy.

### BACKGROUND

Optical systems are sometimes used to image light rays transmitted through an aircraft canopy or through other structures having irregular or tonic curvatures. In certain instances, for example, pilots may use certain electro-optical systems in tactical aircraft to view night-vision imagery through an aircraft canopy. Certain types of aircraft canopies, however, may refract light rays in such a way as to cause astigmatism for an optical system imaging those refracted light rays. The form and magnitude of astigmatism caused by an aircraft canopy may vary at times depending on which of several possible optical paths the optical system may be capable of imaging. For example, the front of an aircraft canopy may cause an astigmatism that is different from the astigmatism that may be caused by the top or the sides of that aircraft canopy.

### SUMMARY OF THE INVENTION

In a method embodiment, a method for correcting astigmatism caused by an aircraft canopy comprises receiving at a compensator module a plurality of light rays that have been refracted by an aircraft canopy. At least two of the refracted light rays have respective foci different from one another and propagate in respective planes that are substantially perpendicular to one another, such that astigmatism occurs. The method further includes using the compensator module to compensate for the astigmatism by providing astigmatic power to the received plurality of light rays. The method also includes providing the plurality of light rays having the astigmatic power compensation to an imaging module. The imaging module is configured to generate imagery using the plurality of light rays having the astigmatic power compensation.

Particular embodiments of the present invention may provide one or more technical advantages. For example, certain embodiments may be configured to dynamically compensate for varying astigmatism caused by an aircraft canopy in real-time as the viewing angle of an imaging system within the aircraft cockpit changes. Alternative embodiments may be configured to fine-tune astigmatic correction for imaging systems permanently fixed within the cockpit of an aircraft or other vehicle.

Certain embodiments may provide all, some, or none of these advantages. Certain embodiments may provide one or more other advantages, one or more of which may be apparent to those skilled in the art from the figures, descriptions, and claims included herein.

### BRIEF DESCRIPTION OF THE DRAWINGS

For a more complete understanding of the present invention and advantages thereof, reference is now made to the following description taken in conjunction with the accompanying drawings, in which:

FIG. 1 is a block diagram of a system capable of performing astigmatic correction to light beams that have passed through an aone or more other transmissive structures having an irregular or tonic curvature, such as an aircraft canopy; and

FIG. 2 is a flowchart illustrating steps that may be performed by the system of FIG. 1 to correct astigmatism caused by aircraft canopy 102.

### DESCRIPTION OF EXAMPLE EMBODIMENTS

According to certain embodiments of the present disclosure, a system and method are provided for correcting astigmatism caused by an aircraft canopy. For example, the light received by certain imaging systems in a cockpit of an aircraft may be modulated by adjusting its astigmatic power to correct astigmatism caused by the aircraft canopy. In certain embodiments, this adjustment can be done on a one time basis to fine tune high resolution cameras that are fixed in the cockpit. In alternative embodiments, the adjustment can be done on a continuous basis based at least in part on a determination of the real-time viewing angle of the imaging system through the aircraft canopy. For example, particular embodiments may be a part of a helmet mounted display system, such that different portions of an aircraft canopy may be included in the optical path of an imaging system as the helmet wearer moves his or her head. The astigmatism caused by an aircraft canopy may vary, however, as a function of the viewing angle though the canopy. For example, the front portion of the aircraft canopy 102 may have astigmatism in the horizontal direction. Either side of the aircraft canopy, however, may have astigmatism in the vertical direction and at a power that is different than the power of the horizontal astigmatism caused by the front portion of the aircraft canopy 102. By predetermining the astigmatic power to apply for the various viewing angles through an aircraft canopy, certain embodiments may be configured to dynamically and continually compensate for astigmatism in real-time as the viewing angle through the aircraft canopy changes. Alternative embodiments may be configured to fine-tune astigmatic correction for imaging systems permanently fixed within the cockpit of an aircraft or other vehicle.

It should be understood at the outset that although example implementations of embodiments of the invention are illustrated below, the present invention should in no way be limited to the example implementations, drawings, and techniques illustrated below. Additionally, the drawings are not necessarily drawn to scale. Although particular embodiments are explained herein with reference to correcting astigmatism caused by an aircraft canopy, particular systems and methods disclosed herein may be used to correct astigmatism caused by one or more other structures having an irregular or toric curvature. In addition, certain embodiments may be configured to correct optical aberrations other than and/or in addition to astigmatism.

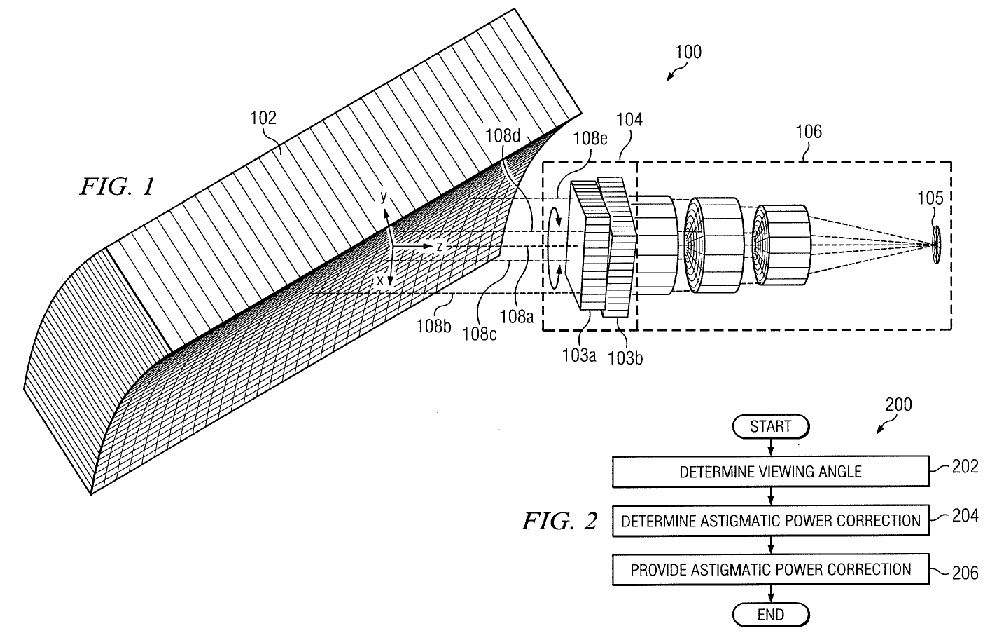

FIG. 1 is a block diagram of a system 100 capable of correcting astigmatism caused by the refraction of light rays 108 as they pass through an aircraft canopy 102. Astigmatism may occur, for example, if at least two light rays 108 in the optical path of system 100 have different foci and propagate in respective planes that are substantially perpendicular to each other. System 100 includes a compensator module 104 optically coupled to an imaging module 106, such that light rays 108 may pass through aircraft canopy 102 and one or more lens elements 103 of compensator module 104 to imaging module 106. As explained further below, system 100 may be capable of modulating light rays 108 incident thereon by adjusting the astigmatic power of light rays 108 to correct astigmatism caused by aircraft canopy 102. In certain embodiments, this adjustment can be done on a one time basis to fine tune an imaging module 104 that may be fixed in the cockpit. In alternative embodiments, the adjustment can be done on a continuous basis based at least in part on a determination of the real-time viewing angle through aircraft canopy 102.

Aircraft canopy 102 generally refers to one or more transmissive structures having an irregular or toric curvature that refracts light in a manner that may cause astigmatism when imaged by an imaging system (e.g., imaging module 104) if no astigmatic correction is applied. For example, aircraft canopy 102 may be the transparent enclosure over the cockpit of some types of aircraft. Although particular embodiments are explained herein with reference to correcting astigmatism caused by aircraft canopy 102, particular systems and methods disclosed herein may be used to correct astigmatism caused by one or more other structures that may cause astigmatism.

Compensator module 104 generally refers to any optical assembly capable of compensating for astigmatism caused by canopy 102 by providing optical power into the optical path. In certain embodiments, compensator module 104 includes one or more adjustable lens elements 103. In addition, compensator module 104 may include, or may have access to, one or more processors, logic encoded in a computer-readable media, one or more motors configured to rotate lens 103, a positioner module configured to determine the current viewing angle of system 100, and/or any other suitable combination of hardware, software, and/or firmware.

Each lens element 103 of compensator 104 may be capable of adjusting astigmatic power of light rays it receives. For example, each lens element 103 may be a cylindrical or torroidal lens. In certain embodiments, lens elements 103a and/or 103b may be capable of rotating about an axis. For example lens element 103a and/or 103b may be rotatable to match the aircraft canopy 102 astigmatism. In addition, the difference in rotational orientation of lens element 103a with respect to 103b may be adjusted to vary the astigmatism correcting power provided by compensator module 104. The rotational orientation of lens elements 103a and/or 103b may be automatically and/or manually adjusted, for example, in continuous increments and/or in fixed increments (e.g., 1, 2, 3, 4, 5, or 10 degree increments). If both lens elements 103a and 103b are rotatable, for example, lens elements 103a and 103b may be rotated with respect to one another to provide a maximum amount of correction in one axis if they are coincident, or to provide a minimum amount of correction if they are counter-rotated up to 90 degrees with respect to one another. In alternative embodiments, portions of imaging module 106 may be rotated and/or counter-rotated with respect to lens element 103a and/or 103b to provide variable astigmatic correction power.

Although FIG. 1 illustrates two lens elements 103a and 103b, certain alternative embodiments may include one lens element 103 or more than two lens elements 103. For systems 100 that are fixed within a cockpit, the use of two or more lens elements 103 may, in certain instances, facilitate fine-tuning the power used to compensate for manufacturing tolerances of aircraft canopy 102 or other components of system 100. For non-fixed systems 100, the use of two or more lens elements 103 may, in certain instances, enhance the efficiency in dynamically adjusting the optical power used to compensate for astigmatism.

As shown in FIG. 1, compensator module 104 may be optically coupled to imaging module 106. For example, compensator module may be positioned between imaging module 106 and aircraft canopy 102 at a position directly in front of imaging module 106 and within the optical path of imaging module 106. However, compensator module 104 may be positioned with respect to imaging module 106 at any suitable angle, provided light may be directed from compensator module to imaging module 106.

Imaging module 106 generally refers to any optical and/or electro-optical subsystem capable of receiving light rays and representing or reproducing those light rays in the form of an image. Imaging module 106 may include, or may be optically coupled to, one or more light sensors 105. Each light sensor 105 may include a focal plane array (FPA) of photodetectors each capable of detecting light within a respective range of wavelengths. For example, light sensor 105 may include an FPA sensitive to the visible color spectrum and/or to infrared radiation. In a particular embodiment, imaging module 106 is a camera located in a forward section of aircraft canopy 102, approximately six inches from the frame of aircraft canopy 102.

In operation, certain light rays 108 may be refracted as they pass through aircraft canopy 102. Astigmatism may occur if at least two of the refracted light rays 108 in the optical path of system 100 have different foci and propagate in respective planes that are substantially perpendicular to each other. Compensator module 104 receives the refracted light rays 108 and compensates for the astigmatism caused by canopy 102 by providing optical power into an optical path directed to imaging module 106.

FIG. 2 is a flowchart 200 illustrating steps that may be performed by system 100 to correct astigmatism caused by aircraft canopy 102. In certain embodiments, the steps of flowchart 200 may be used if system 100 is permanently fixed within the aircraft cockpit, such that the viewing angle through aircraft canopy 102 remains substantially the same. In alternative embodiments, the steps of flowchart 200 may be used if the viewing angle of system 100 is not permanently fixed within the aircraft cockpit and the viewing angle through aircraft canopy 102 may change at any moment. If the viewing angle of system 100 may change at any moment, compensator module 104 may dynamically adjust, on a continuous basis, the optical power provided into the optical path based at least in part on a real-time determination of current viewing angle through the aircraft canopy. The viewing angle of system 100 may not be fixed, for example, if system 100 is physically attached to an apparatus worn by a human. For example, certain systems 100 may be attached to and/or form a portion of a helmet (e.g., a helmet-mounted display system), goggles (e.g., night vision goggles), or other apparatus that may be worn by a pilot, copilot, navigator, passenger, etc. In certain helmet-mounted display applications, the viewing angle of system 100, including its central optical axis, may change as the helmet wearer moves his or her head.

In step 202, a determination is made regarding which one of a plurality of viewing angles through aircraft canopy 102 corresponds to an optical path of imaging module 106. A plurality of viewing angles may be available in certain circumstances where system 100 may be configured to be articulated within a cockpit of the aircraft. To compensate for variable astigmatism caused by different view angles, the surface area of aircraft canopy 102 may be partitioned into multiple sections, each representing a collection of viewing angles through aircraft canopy 102. System 100 may map each section to a respective astigmatic correction power value that system 100 will use to compensate for a predetermined astigmatism caused by that section. During operation, system 100 may determine in real-time the current viewing angle of system 100 through aircraft canopy 102. As shown in FIG. 1, for example, system 100 may determine that the current viewing angle is centered on an axis parallel to the z-axis and coincident with light ray 108a.

In step 204, an astigmatic correction power is determined. For example, data may be accessed that represents an astigmatic power sufficient to substantially correct the astigmatism caused by aircraft canopy 102 along the particular viewing angle determined in step 202. For example, astigmatic power may be determined such that it corrects 80% or more of the astigmatism caused by aircraft canopy 102 along the particular viewing angle determined in step 202; however, any suitable threshold percentage may be used (e.g., 85%, 90%, 95%, 99%, etc.). In certain embodiments, compensator module 104 may access, or may otherwise include, a database that maps each of a plurality of possible viewing angles to a respective predetermined astigmatic correction power. For example, at least 12 different viewing angles substantially parallel to the horizon may be accessible to system 100, with each of the twelve viewing angles corresponding to a respective position of a clock (e.g., 1 o'clock level, 3 o'clock level, 6 o'clock level, 9 o'clock level, 12 o'clock level, etc.). The database may include predetermined entries that map each of those possible twelve or more viewing angles to a respective astigmatic power sufficient to substantially correct astigmatism caused by the particular section of aircraft canopy 102 intersecting the viewing angle. A lookup may be performed in the database to determine which astigmatic correction power to use for the section of aircraft canopy 102 including the viewing angle determined in step 202.

In step 206, the astigmatic correction power determined in step 204 is provided by compensator module 104 to the optical path of imaging module 106. In this manner, the astigmatism that may be caused by aircraft canopy 102 may not be reproduced in the imagery generated by imaging module 106. In certain embodiments, this adjustment of astigmatic power of step 206 may be done on a one time basis to fine tune high resolution cameras that are fixed in the cockpit. In alternative embodiments, the adjustment of astigmatic power of step 206 may be done on a continuous basis based at least in part on the determination in step 202 of the real-time viewing angle of imaging system 106 through aircraft canopy 102.

The astigmatic correction power provided by compensator module 104 may be varied, for example, over a range from 0 to approximately twice the power of one lens element 103a or 103b included in compensator module 104. The magnitude of the astigmatic correction power introduced by compensator module 104 may be optimized by rotating lens 103a and/or lens 103b to change the difference in rotational angle between lens 103a and lens 103b about a rotational axis. As shown in FIG. 1, for example, the rotational axis of lens 103a and/or 103b may, in certain instances, be coincident with the z-axis, the optical centerline of compensator module 104, the optical centerline of imaging module 106, and/or light ray 108a.

In particular embodiments, compensator 104 may provide a maximum amount of correction power along an optical path if lens elements 103a and/or 103b are rotated until their differences in rotational orientation is minimized. For example, compensator 104 may provide a maximum amount of correction power to an optical path if there is approximately 0 degrees difference in rotational angle between lens 103a and lens 103b about a shared rotational axis. Alternatively, compensator 104 may provide a minimum amount of correction power to an optical path if lens elements 103a and/or 103b are rotated to maximize the rotational angle between lens elements 103a and 103b. For example, compensator 104 may provide little to no amount of correction power to an optical path if there is approximately 90 degrees difference in rotational angle between lens 103a and lens 103b about a shared rotational axis. Positional technology may be used to determine which way to rotate lens 103a and/or 103b (i.e., clockwise or counter-clockwise) in order to achieve the desired amount of correction power as efficiently as possible.

The components of the systems and apparatuses disclosed herein may be integrated or separated. For example, all or a portion of compensator module 104 may be included within imaging module 106. Moreover, the operations of the systems and apparatuses may be performed by more, fewer, or other components. The methods may include more, fewer, or other steps. For example, step 202 may not be used in certain embodiments where system 100 is configured to be permanently fixed within the cockpit of an aircraft, though an astigmatic correction power may be determined and provided by compensator module 104 in a manner substantially similar to steps 204 and 206, respectively, of FIG. 2. Additionally, steps may be performed in any suitable order. Particular operations of the systems and apparatuses disclosed herein may be performed using any suitable logic embodied in computer-readable media.

Although the present disclosure has been described above in connection with several embodiments, a myriad of changes, substitutions, variations, alterations, transformations, and modifications may be suggested to one skilled in the art, and it is intended that the present invention encompass such changes, substitutions, variations, alterations, transformations, and modifications as fall within the spirit and scope of the appended claims.

What is claimed is:

1. A method for correcting astigmatism caused by an aircraft canopy, comprising:
determining which one of a plurality of viewing angles through an aircraft canopy corresponds to an optical path of an imaging system configured to be articulated within a cockpit of the aircraft;
accessing data representing an astigmatic power sufficient to substantially compensate for astigmatism associated with the determined one of the plurality of viewing angles through the aircraft canopy, the astigmatism caused by refraction of light by the aircraft canopy; and
providing the astigmatic power to the optical path of the imaging system, the provided astigmatic power substantially correcting the astigmatism caused by the aircraft canopy.

2. The method of claim 1, wherein providing the astigmatic power to the optical path of the imaging system comprises:
determining an orientation angle of a rotatable lens element corresponding to the astigmatic power; and
rotating the lens element until the lens element is oriented at the determined orientation angle.

3. The method of claim 1, wherein providing the astigmatic power to the optical path of the imaging system comprises rotating two lens elements about an axis, the two lens elements configured to rotate with respect to one another such that a difference in the angle of rotation between the two lens elements is within the range of 0 to 90 degrees, inclusively, the 0 and 90 degree differences in the angle of rotation between the two lens elements corresponding to a maximum and a minimum astigmatic power, respectively.

4. The method of claim 1, wherein providing the astigmatic power to the optical path of the imaging system comprises rotating a plurality of lens elements; and
wherein the provided astigmatic power is substantially equal to twice the maximum power of at least one of the plurality of lens elements.

5. The method of claim 1, wherein providing the astigmatic power to the optical path of the imaging system comprises providing the astigmatic power to the optical path of the helmet-mounted imaging system using a compensator module optically coupled to the helmet-mounted imaging system, the compensator module comprising one or more lens elements each configured to provide a variable amount of astigmatic power to the optical path of the helmet-mounted imaging system.

6. The method of claim 1, wherein the imaging system is coupled to a helmet such that the optical path of the imaging system varies as a function of the orientation of the helmet relative to the aircraft canopy.

7. The method of claim 1, wherein the imaging system is coupled to a goggles such that the optical path of the imaging system varies as a function of the orientation of the goggles relative to the aircraft canopy.

8. The method of claim 1, wherein determining which one of the plurality of viewing angles through the aircraft canopy corresponds to the optical path of the helmet-mounted imaging system is in response to a determination that the optical path of the helmet-mounted imaging system has changed.

9. The method of claim 1, wherein the helmet-mounted imaging system is configured to generate imagery using light rays transmitted along the optical path.

10. A method for correcting astigmatism caused by an aircraft canopy, comprising:
receiving at a compensator module a plurality of light rays that have been refracted by an aircraft canopy, at least two of the refracted light rays having respective foci different from one another and propagating in respective planes that are substantially perpendicular to one another, such that astigmatism occurs;
using the compensator module, substantially compensating for the astigmatism by providing astigmatic power to the received plurality of light rays; and
providing the plurality of light rays having the astigmatic power compensation to an imaging module configured to generate imagery using the plurality of light rays having the astigmatic power compensation.

11. The method of claim 10, wherein the plurality of light rays received at the compensator module each have infrared wavelengths; and
wherein the imagery generated by the imaging module is night-vision imagery.

12. The method of claim 10, wherein the plurality of light rays received at the compensator module each have wavelengths outside of the visible spectrum comprising 390 nanometers to 750 nanometers, inclusively.

13. The method of claim 10, wherein substantially compensating for the astigmatism by providing astigmatic power to the received plurality of light rays comprises rotating a lens element of the compensator module until the lens element is oriented at an angle corresponding to the astigmatic power compensation.

14. The method of claim 10, wherein substantially compensating for the astigmatism by providing astigmatic power to the received plurality of light rays comprises rotating two lens elements about an axis, the two lens elements configured to rotate with respect to one another such that a difference in the angle of rotation between the two lens elements is within the range of 0 to 90 degrees, inclusively, the 0 and 90 degree differences in the angle of rotation between the two lens elements corresponding to a maximum and a minimum astigmatic power, respectively.

15. The method of claim 10, wherein substantially compensating for the astigmatism by providing astigmatic power to the received plurality of light rays comprises rotating a plurality of lens elements of the compensator module; and
wherein the astigmatic power compensation provided to the plurality of light rays is substantially equal to twice the maximum power of at least one of the plurality of lens elements.

16. The method of claim 10, wherein substantially compensating for the astigmatism by providing astigmatic power to the received plurality of light rays comprises providing the astigmatic power to the optical path of the helmet-mounted imaging system using a compensator module optically coupled to the helmet-mounted imaging system, the compensator module comprising one or more lens elements each configured to provide a variable amount of astigmatic power to the optical path of the helmet-mounted imaging system.

17. The method of claim 10, wherein the imaging module is fixed to the aircraft such that an optical path of the imaging module is fixed relative to the aircraft canopy.

18. The method of claim 10, wherein the imaging module is not fixed to the aircraft such that an optical path of the imaging module is changeable relative to the aircraft canopy.

19. A system for correcting astigmatism caused by an aircraft canopy, comprising:
a compensator module comprising at least one rotatable lens element, the compensator module configured to:
determine which one of a plurality of viewing angles through an aircraft canopy corresponds to an optical path of an imaging system;
access data representing an astigmatic power sufficient to substantially compensate for astigmatism associated with the determined one of the plurality of viewing angles through the aircraft canopy, the astigmatism caused by refraction of light by the aircraft canopy; and
provide the astigmatic power to the optical path of the imaging system using the plurality of rotatable lens elements, the provided astigmatic power substantially correcting the astigmatism caused by the aircraft canopy.

20. The system of claim 19, wherein the compensator module is further configured to modify the astigmatic power provided by the at least one lens element based at least in part on a determination that the optical path of the imaging system has changed such that a different one of the plurality of viewing angles though the aircraft canopy corresponds to the changed optical path of the imaging system.
